(19) United States
(12) Patent Application Publication
(10) Pub. No.: US 2007/0109279 A1
(43) Pub. Date: May 17, 2007

(54) Method and apparatus for identifying locations of ambiguous multiple touch events

(75) Inventor: Michael R. Sigona, Munich (DE)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Raychem Gmbh, Ottobrunn (DE)

(21) Appl. No.: 11/274,228

(22) Filed: Nov. 15, 2005

(51) Int. Cl. G09G 5/00

(52) U.S. Cl. 345/177

(57) ABSTRACT

Method and apparatus for identifying locations on a touchscreen of at least two touch events that occur within a predetermined time of one another comprises monitoring the touchscreen for touch events. Each touch event occurs at a discrete location on the touchscreen defined by an XY coordinate pair. A coordinate series is generated including at least two X coordinates and at least two Y coordinates when first and second touch events occur within a predetermined time of one another. When a release event occurs, the release event is correlated with one of the X coordinates and one of the Y coordinates in the coordinate series to form a first XY coordinate pair corresponding to the first touch event. The first XY coordinate pair associated with the first touch event is output.

### BACKGROUND OF THE INVENTION

This invention relates generally to touch input systems, and more particularly, to touch input systems in which there can be multiple touches overlapping in time, and to methods and apparatus for identifying the locations of multiple touch inputs

Touch input systems have become ubiquitous throughout industrialized countries. These systems have replaced or supplemented conventional input systems, such as a keyboard or mouse in many applications, including for example, information kiosks, retail point of sale, order input (e.g. restaurants), and industrial line operations. Various sensing technologies are applied in touch input systems currently in the marketplace, including acoustic, resistive, capacitive and infrared. A touch input system is typically used in conjunction with some type of information display system that may include a computer. When a user touches a displayed object, the touch input system communicates the location of the touch to the system.

FIGS. 1 and 2 show conventional touch sensor systems and touch input systems. The touch sensor system 100 generally comprises a touchscreen 105 (also called a touch screen), an example of which may be a touch sensor having a transparent substrate. The system 100 also comprises a lead 111 coupling a controller 110 to the touchscreen 105. A touchscreen system comprising the touchscreen 105 and controller 110 may be used in conjunction with a display device 115. The touch sensor system 100 is configured to respond to a touch on the touchscreen 105 by causing acoustic waves to be transmitted across the touchscreen 105, one or more of which are modulated in the presence of the touch. The controller 110 in turn uses the modulated signal from the waves to identify the location of the touch on the touchscreen 105. The controller 110 also uses the modulated signal to distinguish between valid touches and invalid signals (e.g., signals generated by contamination on the surface of the screen). If the controller 110 identifies a touch as valid, it transmits the touch's location to a host computer (not shown) that then implements a corresponding computer finction to display the pertinent information, e.g., graphics, on the display device 115. Graphics or other information may be displayed on the display device 115 in response to an operator's command, e.g. touching a particular area of the touchscreen 105.

FIG. 2 illustrates an acoustic wave touch input system 102. A transparent sensor substrate 120 having a surface 122 covers a screen of a display system. The transparent sensor substrate 120 is typically made of glass. The wave energy is directed along one or more paths that form an invisible XY grid overlaying the substrate surface 122 wherein a touch to the surface 122 causes wave energy to be attenuated.

A first transmitting transducer 125 and a first receiving transducer 135 are provided in two corners of the substrate 120, with the corners being located on a first vertical side of the substrate 120. The first transmitting transducer 125 transmits acoustic waves in the horizontal right direction to be received by the first receiving transducer 135. A second transmitting transducer 130 and a second receiving transducer 140 are oriented perpendicularly to the first transmitting and receiving transducers 125 and 135 on a first horizontal side of the substrate 120. Both the transmitting transducers 125 and 130 and the receiving transducers 135 and 140 may be, for example, piezoelectric transducers. Two reflector arrays 200 and 205 are provided on both horizontal sides of the substrate 120, and two reflector arrays 210 and 215 are provided on both vertical sides of the substrate 120. The reflector arrays partially reflect waves from the transmitting transducers to the receiving transducers.

The controller 110 sends signals to the transmitting transducers 125 and 130 through lines 160 and 165, and the transmitting transducers 125 and 130 generate acoustic energy that is launched across the substrate 120 and reflected by the reflector arrays. The controller 110 accepts signals from the receiving transducers 135 and 140 through lines 190 and 195, and the received signals include timing and signal amplitude. The controller 110 comprises coded instructions (stored, for example, in a memory of a microprocessor), which when executed, perform steps to control and process the relevant signals. The controller 110 need not comprise a computer, but may be implemented in hardware, firmware, software or any combination thereof. The time the wave takes to travel from the transmitting transducers 125 and 130 to the receiving transducers 135 and 140 via the reflector arrays 200, 205, 210 and 215 is dependent on the path length, and therefore the position of an attenuation within the wave can be correlated to the time at which it was received relative to the time it was launched. Waves are periodically and repetitively propagated in both the X and Y directions of the substrate 120 in order to allow the detection of coordinates of a touch event location 250. The time between the repetitive propagation of waves is the sampling time.

One disadvantage of touch input systems incorporating the propagation and detection of acoustic waves is that if two or more points are pressed or touched concurrently or within a specific same sampling period of the system, the receiving transducers 135 and 140 will detect multiple X coordinates and multiple Y coordinates within a single time interval in which the coordinates are read, and as such the touch location may be identified by multiple distinct coordinate pairs. This is illustrated in FIG. 3 for the case of two concurrent touch events indicated at locations 250 and 251. In the example shown in FIG. 3, there are two possible combinations of X and Y pairs which could indicate touch locations 252 and 253, which are not the actual touch locations. Therefore, for applications that need the capability to sense multiple concurrent touches, improvements over conventional systems are desired.

Multiple touches that overlap in time may be detected as simultaneous events. Simultaneous touches occur when the start times for two touches are the same within the time resolution of the system (e.g., the time resolution of the microchip controller of the system). Features of the system that can limit time resolution include analog to digital sampling rate, wave propagation velocity, bandwidth of analog circuits, and the like. For example, if the controller 110 samples the touchscreen 105 at a rate of 100 times per second, then touch events arriving within 0.01 second of each another cannot be resolved in time. In some applications, it is likely that two touches will occur somewhere in the screen within 0.01 second. For example, in a video game involving head-to-head competition, this probability may be very high.

Therefore, a need exists for a method and apparatus for identifying the locations of touch events occurring within the same time period. Certain embodiments of the present invention are intended to meet these needs and other objectives that will become apparent from the description and drawings set forth below.

### BRIEF SUMMARY OF THE INVENTION

In one embodiment, a method for identifying locations on a touchscreen of at least two touch events that occur within a predetermined time of one another comprises monitoring the touchscreen for touch events. Each touch event occurs at a discrete location on the touchscreen defined by an XY coordinate pair. A coordinate series is generated including at least two X coordinates and at least two Y coordinates when first and second touch events occur within a predetermined time of one another. When a release event occurs, the release event is correlated with one of the X coordinates and one of the Y coordinates in the coordinate series to form a first XY coordinate pair corresponding to the first touch event. The first XY coordinate pair corresponding to the first touch event is output.

In another embodiment, an apparatus for correlating coordinates representative of at least two touch events on a touchscreen that occur within a predetermined time of one another comprises a touchscreen having a touch surface for receiving touch events. Each touch event occurs at a discrete location on the touch surface defined by an XY coordinate pair. A touchscreen controller monitors the touch surface for the touch events. The touchscreen controller identifies at least two X coordinates and at least two Y coordinates when at least two touch events occur within a predetermined time of one another. A buffer receives at least two X coordinates and at least two Y coordinates from the touchscreen controller. The touchscreen controller forms a first XY coordinate pair based on a release event associated with a first touch.

In another embodiment, a method for pairing coordinates representative of multiple touch events on a touch apparatus that occur within the same measurement period comprises receiving a first set of signals representative of coordinate locations along a first axis. A second set of signals representative of coordinate locations along a second axis is received. Consecutively received sets of signals are compared to the first and second sets of signals to identify a missing signal component in the consecutively received sets of signals. Coordinate pairs are identified based on the missing signal component.

### BRIEF DESCRIPTION OF THE DRAWINGS

FIG. 1 shows a conventional touch sensor system.

FIG. 2 illustrates an acoustic wave touch input system.

FIG. 3 illustrates the case of two concurrent touch events.

FIG. 4 illustrates a touch sensor system capable of resolving multiple touch situations in accordance with an embodiment of the present invention.

FIG. 5 illustrates an acoustic wave touch input system in accordance with an embodiment of the present invention.

FIG. 6 illustrates a method for resolving multiple touch situations in accordance with an embodiment of the present invention.

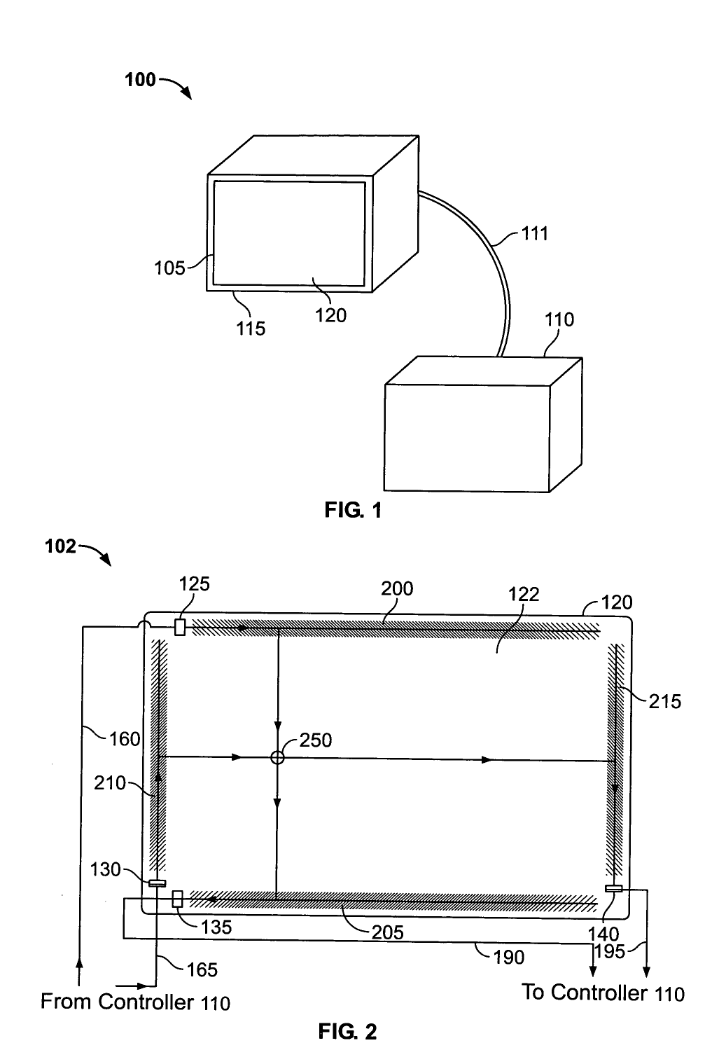

The foregoing summary, as well as the following detailed description of certain embodiments of the present invention, will be better understood when read in conjunction with the appended drawings. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed imaging software package, and the like. It should be understood that the various embodiments are not limited to the arrangements and instrumentality shown in the drawings.

### DETAILED DESCRIPTION OF THE INVENTION

FIG. 4 illustrates a touch sensor system 260 capable of resolving multiple touch situations in accordance with an embodiment of the present invention. The touch sensor system 260 comprises the display device 115 with the touchscreen 105 and transparent sensor substrate 120 as previously discussed. A controller 262 is interconnected with the touchscreen 105 with the lead 111. The controller 262 further comprises at least one buffer 264 and 266 for temporarily storing coordinate information and/or signals representative of coordinate information.

A microprocessor 268 may receive signals from the touchscreen 105 and determine the coordinate information of touch events as discussed below. The microprocessor 268 may then output the coordinate information to another device such as a central or host computer 272 via lead 270. It should be understood that the coordinate information passed through the lead 270 is representative only. In addition, information may be output in many forms and formats by the computer 272, such as text or graphics on the display device 115, a different display device or monitor, a light, a bell, an initiation or termination of an action, and the like. Therefore, the information passed through the lead 270 may change based on the purpose of the touch sensor system 260. Optionally, the controller 262 may be located within a monitor or the display device 115, in a separate unit as illustrated, or within the computer 272.

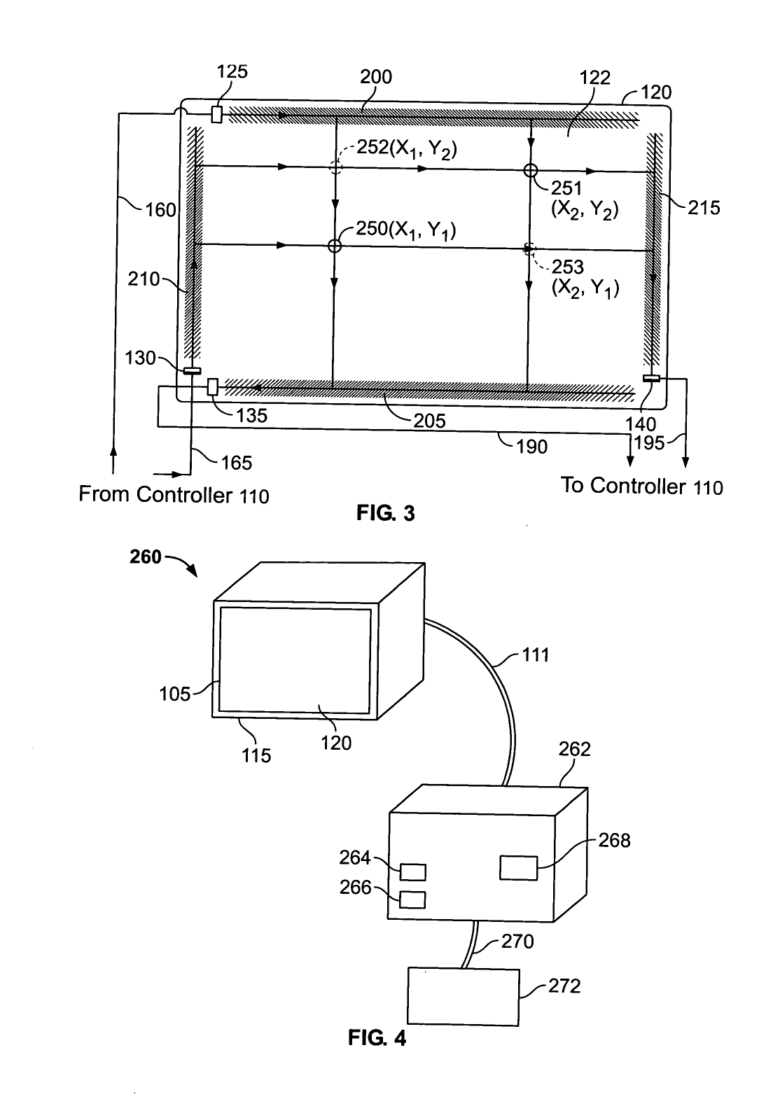

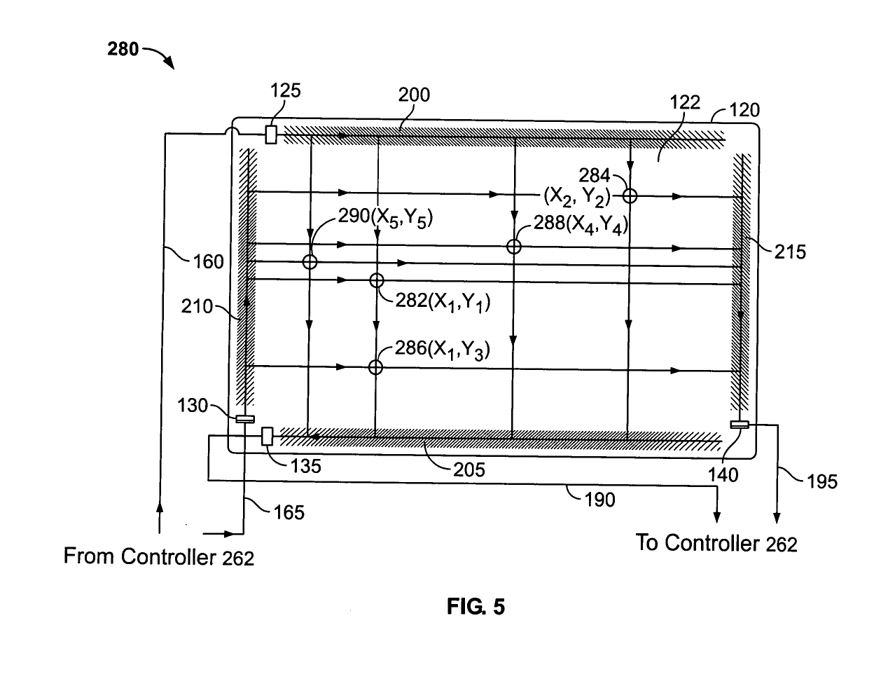

FIG. 5 illustrates an acoustic wave touch input system 280 in accordance with an embodiment of the present invention. Elements in common with FIGS. 2 and 3 are labeled with like item numbers. Although surface acoustic waves (SAW) are illustrated, it should be understood that other sensing technologies may also be used, including, but not limited to, acoustic, resistive, capacitive and infrared.

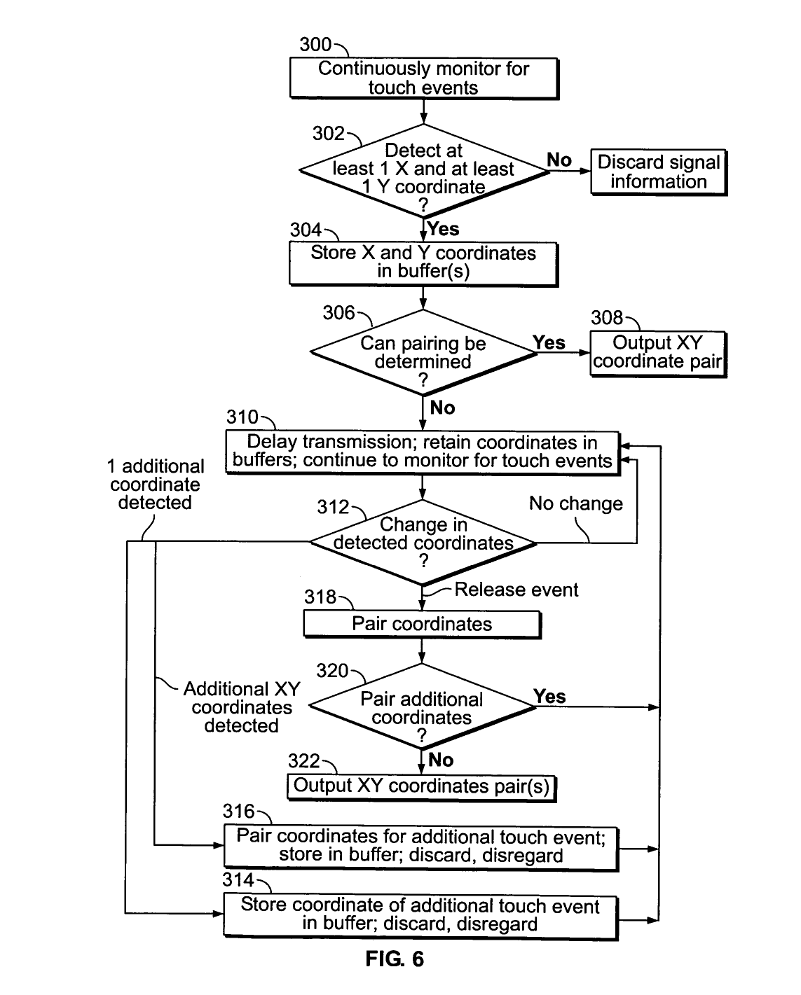

FIG. 6 illustrates a method for resolving multiple touch situations in accordance with an embodiment of the present invention. FIGS. 4 to 6 will be discussed together.

In step 300, the controller 262 begins the scan process to continuously monitor the touchscreen 105 for touch events. For example, the controller 262 may send a signal to the first transmitting transducer 125 via line 160. The first receiving transducer 135 sends a first returning signal via line 190 to the controller 262. The controller 262 then sends a signal to the second transmitting transducer 130 via line 165. The second receiving transducer 140 sends a second returning signal via line 195 to the controller 262. As stated previously, the returning signal includes timing and signal amplitude information representative of touch events, if present. Therefore, controller 262 constantly sends and receives signals in both the X and Y directions in order to detect the coordinates of one or more touch events. The time between the repetitive propagation of waves is the sampling rate or time. A measurement period may be determined as the time period for the microprocessor 268 to send and receive the first and second sets of signals.

In step 302, the microprocessor 268 analyzes the first and second returning signals to determine whether one or more X and Y coordinates are detected. If no X or Y coordinates are detected, the first and second returning signal information may be discarded. If at least one X and at least one Y coordinate are detected, flow passes to step 304. It should be understood that steps 300 and 302 are repeatedly performed so that the touchscreen 105 is continuously monitored for touch events.

In step 304, the microprocessor 268 stores the detected X and Y coordinates in one or more buffers 264 and 266. For example, a first coordinate series of X coordinates may be stored in a memory or buffer 264 and a second coordinate series of Y coordinates may be stored in a memory or buffer 266. Alternatively, a single buffer 264 may be used to store all detected coordinates. Optionally, sets of signals representative of the coordinates may be stored, wherein the microprocessor 268 or other device may identify the actual X and Y coordinate locations later.

In step 306, the microprocessor 268 determines whether the pairing of the X and Y coordinates can be determined; indicating that a discrete location has been touched on the touchscreen 105. For example, if a single touch occurs at touch location 282, an X₁ coordinate and a Y₁ coordinate are returned. The microprocessor 268 forms the coordinate pair (X₁, Y₁), and in step 308, the microprocessor 268 transmits the XY coordinate pair, (X₁, Y₁) and clears the buffers 264 and 266. The XY coordinate pair may be transmitted to a central or host computer 272 for implementation of the desired function.

However, if touch events occur at touch locations 282 and 284 such that, in step 302, the microprocessor 268 detects coordinate series X₁, X₂ and Y₁, Y₂ within a predetermined time or measurement period of one another, the pairing of the X and Y coordinates cannot be determined and flow passes to step 310. The predetermined time may, for example, be based on a sampling rate or time in which the touchscreen 105 is monitored for touch events (step 300). It should be understood that more than two touch events may be detected at the same time, resulting in additional X and Y coordinates to be paired. For example, touch location 288 (X₄, Y₄) may be detected at the same time as touch locations 282 and 284.

In step 310, the microprocessor 268 delays the transmission of any coordinates. Continuing the example above of touch locations 282 and 284, the coordinate series X₁, X₂ and Y₁, Y₂ are retained in the buffers 264 and 266. The microprocessor 268 continues to scan for touch events, such as in step 300.

In step 312, the microprocessor 268 compares the currently detected coordinates (such as a consecutively acquired coordinate series or sets of signals) with the coordinates and/or signals saved in the buffers 264 and 266 to determine if a change has been detected. If the same coordinates, X₁, X₂ and Y₁, Y₂ are detected, the microprocessor 268 determines that continuous touches have occurred and flow returns to step 310. No coordinates are transmitted, the current coordinates remain in the buffers 264 and 266, and the microprocessor 268 continues to scan for touch events. Optionally, the microprocessor 268 may identify the coordinates as unchanged when within a tolerance, such as to account for a slight finger movement or roll of the user's finger along the touch surface.

Returning to step 312, the microprocessor 268 may also determine that a change has occurred based on one of relative timing of the touch events, absolute touch intensity, rate of change of touch intensity, correlation of touch intensity over multiple measurement cycles, and touch movement (i.e. dragging or rolling finger). These changes may allow the microprocessor 268 to pair coordinates by using other comparison methods in addition to the method of FIG. 6.

If the microprocessor 268 detects one additional coordinate, either an X or Y coordinate, but not both, flow passes to step 314. This may occur if touch location 286, having the coordinates (X₁, Y₃), is detected. Therefore, the X coordinate locations of touch locations 282 and 286 are the same, and the coordinates cannot be paired. The Y₃ coordinate is stored, such as in the buffer 266, and flow returns to step 310. Alternatively, the microprocessor 268 may discard or disregard the additional coordinate depending upon the application.

If the microprocessor 268 detects an additional touch event, such as at touch location 290 having coordinates (X₅, Y₅), flow passes from step 312 to step 316. The microprocessor 268 can pair the new set of coordinates (X₁5, Y₅), however, depending upon the processing algorithms and system implementation, the microprocessor 268 may transmit the paired coordinates (X₅, Y₅), save the paired coordinates (X₅, Y₅) in one of the buffers 264 and 266, or discard the paired coordinates (X₅, Y₅).

If the microprocessor 268 detects that one less X and one less Y coordinate is present in a subsequent returned signal, a release event has occurred and flow passes from step 312 to step 318. This may occur when a user lifts a finger or stylus from the touchscreen 105. In step 318, the microprocessor 268 correlates the release event with one of the touch events, such as by comparing the subsequently returned signals to the coordinates or signals stored in the buffers 264 and 266 to identify the missing X and Y coordinates. The missing X and Y coordinates or signal components correlate to a touch location and can be paired. Therefore, if the microprocessor 268 identifies that the returned signals now contain only the X₂ and Y₂ coordinates, the microprocessor 268 can pair the previously identified coordinates (X₁, Y₁) and (X₂, Y₂), which were stored in the buffers 264 and 266.

In step 320, the microprocessor 268 determines whether additional coordinates are to be paired. For example, if touch events occurred at the touch locations 282, 284 and 288 and were detected in step 302 at substantially the same time or within a predetermined time of one another, in step 318 the microprocessor 268 would be able to pair only the X and Y coordinates associated with the lift off event. Using the example above, the microprocessor 268 has paired the coordinates of touch location 282 (X₁, Y₁) (step 318) and returns to step 310 if the additional coordinates are to be paired. Additional coordinates may be paired by detecting a second lift off or release event. Depending upon the processing algorithms being used, the microprocessor 268 may output the paired coordinates or save the paired coordinates in one of the buffers 264 and 266. The unpaired coordinates remain stored in the buffers 264 and 266.

In step 320, if no additional coordinates are to be paired, flow passes to step 322, and the XY coordinate pair(s) are output or transmitted to the central or host computer 272 for implementation of the desired function. Optionally, the microprocessor 268 may also identify and/or transmit the coordinate pair associated with the lift off, and/or identify and/or organize the sets of coordinates based on a predetermined hierarchy.

In addition to video games, dual or multiple touch situations may also be encountered when using keyboards simulated on a touch display, such as when selecting a particular option, object or key combination on a keyboard, such as the shift key in combination with another key to create a capital letter or characters used in emoticons. Also, international keyboards have the need to resolve multiple touch situations to create character combinations. In addition, dual or multiple touch capability may be desired to implement critical situations, where it is required to select certain combinations of keys or inputs to initiate or terminate an action, such as simultaneous selection of two keys or touch points to confirm the start of a potentially dangerous operation in a factory.

While the invention has been described in terms of various specific embodiments, those skilled in the art will recognize that the invention can be practiced with modification within the spirit and scope of the claims.

What is claimed is:

1. A method for identifying locations on a touchscreen of at least two touch events that occur within a predetermined time of one another, the method comprising:
monitoring the touchscreen for touch events, each touch event occurring at a discrete location on the touchscreen defined by an XY coordinate pair;
generating a coordinate series including at least two X coordinates and at least two Y coordinates when first and second touch events occur within a predetermined time of one another;
when a release event occurs, correlating the release event with one of the X coordinates and one of the Y coordinates in the coordinate series to form a first XY coordinate pair corresponding to the first touch event; and
outputting the first XY coordinate pair associated with the first touch event.

2. The method of claim 1, further comprising outputting a second XY coordinate pair from the coordinate series when the first XY coordinate pair is output.

3. The method of claim 1, further comprising storing the coordinate series in buffers and comparing the stored coordinate series with a new coordinate series.

4. The method of claim 1, wherein the first and second touch events occur substantially simultaneously.

5. The method of claim 1, wherein the correlating includes comparing consecutively acquired first and second coordinate series to identify differences there between.

6. The method of claim 1, wherein the first XY coordinate pair is output only after the release event occurs that is associated with the first touch event.

7. The method of claim 1, further comprising pairing the X coordinates and the Y coordinates based on one of relative timing of the touch events, absolute touch intensity, rate of change of touch intensity, correlation of touch intensity over multiple measurement cycles, and movement of at least one of the X and Y coordinates.

8. The method of claim 1, wherein the predetermined time is based on a sampling rate at which the touchscreen is monitored for touch events.

9. An apparatus for correlating coordinates representative of at least two touch events on a touchscreen that occur within a predetermined time of one another, the apparatus comprising:
a touchscreen comprising a touch surface for receiving touch events, each touch event occurring at a discrete location on the touch surface defined by an XY coordinate pair;
a touchscreen controller for monitoring the touch surface for the touch events, the touchscreen controller identifying at least two X coordinates and at least two Y coordinates when the at least two touch events occur within a predetermined time of one another; and
a buffer for receiving from the touchscreen controller the at least two X coordinates and at least two Y coordinates, the touchscreen controller forming a first XY coordinate pair based on a release event associated with a first touch.

10. The apparatus of claim 9, the touchscreen controller fturther comprising an output for outputting the first XY coordinate pair and a second XY coordinate pair associated with a second touch.

11. The apparatus of claim 9, the touchscreen controller further comprising a microprocessor having a sampling rate, the predetermined time being based on the sampling rate.

12. The apparatus of claim 9, the touchscreen controller receiving a subsequent set of coordinates and comparing the subsequent set of coordinates with the at least two X coordinates and the at least two Y coordinates in the buffer to determine the first XY coordinate pair.

13. The apparatus of claim 9, the touchscreen controller further comprising a microprocessor identifying the release event based on a comparison of first and second sets of consecutively acquired coordinates, the second set of coordinates comprising at least one less X and one less Y coordinate.

14. A method for pairing coordinates representative of multiple touch events on a touch apparatus that occur within the same measurement period, comprising:
receiving a first set of signals representative of coordinate locations along a first axis;
receiving a second set of signals representative of coordinate locations along a second axis;
comparing consecutively received sets of signals to the first and second sets of signals to identify a missing signal component in the consecutively received sets of signals; and
identifying coordinate pairs based on the missing signal component.

15. The method of claim 14, the consecutively received sets of signals further comprising sets of signals representative of the coordinate locations along the first and second axis, the missing signal component representative of one of the coordinate locations.

16. The method of claim 14, further comprising:
storing the first and second sets of signals in a buffer; and
retaining the first and second sets of signals in the buffer until the coordinate pairs are identified.

17. The method of claim 14, the missing signal component being representative of a first coordinate location along the first axis and a second coordinate location along the second axis, the method further comprising pairing the first and second coordinate locations to form a coordinate pair.

18. The method of claim 14, further comprising:
prior to identifying the coordinate pairs, storing the first and second sets of signals in a memory; and
after identifying the coordinate pairs, outputting the coordinate pairs from the memory.

19. The method of claim 14, wherein the first and second sets of signals being representative of more than two coordinate locations along the first and second axis, the method further comprising:
identifying a first coordinate pair based on a first missing signal component; and
identifying a second coordinate pair based on a second missing signal component.

20. The method of claim 14, the first and second sets of signals being received during a first measurement period, the consecutively received sets of signals being received during a measurement period subsequent to the first measurement period.
